(19) United States
(12) Patent Application Publication
(10) Pub. No.: US 2018/0082019 A1
(43) Pub. Date: Mar. 22, 2018

(54) SYSTEM AND METHODS FOR MANAGING HEALTHCARE DATA

(71) Applicant: Bedside, Inc., Irvine, CA (US)

(72) Inventor: Greyson BOERNER, Irvine, CA (US)

(21) Appl. No.: 15/272,260

(22) Filed: Sep. 21, 2016

(51) Int. Cl. G06F 19/00; H04L 29/06; G06F 17/30

(52) U.S. Cl. CPC G06F 19/322; H04L 67/42; G06F 19/321; G06F 17/30867; G06F 19/3406; G06F 19/328; H04L 63/04

(57) ABSTRACT

Some embodiments are directed to a method of exchanging messages between an assisted living service provider and one or more subscribers. The method includes retrieving, by a server, data corresponding to a client of the assisted living service provider from one or more medical record databases. The method further includes transforming, by the server, the retrieved data in accordance with a predefined format. The method also includes storing the transformed data in a local database communicably coupled to the server. The method further includes sending one or more messages to one or more subscriber devices, the one or more messages including at least one of a health status, an activity status, an assistance status, a nutrition status and a medication status of the client.

### BACKGROUND

The disclosed subject matter relates to assisted care, and more specifically to system and methods for communicating information of a patient in an assisted living and skilled nursing environment to one or more designated subscribers. The designated subscriber may be a guardian or a family member of the patient. In particular, the disclosed subject matter relates to exchange of data between an assisted living service provider and a plurality of subscribers who have access to regular updates concerning a patient under the care of the assisted living service provider. The assisted living or skilled nursing service provider or an assisted living/skilled nursing facility is a housing facility for differently abled or incapacitated people, senior citizens or for adults who cannot live independently.

The assisted living/skilled nursing services provide day to day care for millions of people. As a part of the living environment, the assisted living services typically provide health care to its clients or patients. The assisted living service provider enrolls one person of contact for each client or patient. The assisted living service provider contacts the person of contact of the client or the patient in case of any emergency. Thereafter, the person of contact can typically convey the emergency message to other members of the family.

### SUMMARY

All information related to a patient's medical history, diagnostic images, test results, periodic health updates and/or various reports are stored as healthcare data. Various system and services for storing the healthcare data in digital compressed form on a medical record database are well known.

However, the healthcare data, which is shared with the patient and/or concerned healthcare providers is confidential information and unauthorized access to the information can lead to legal liabilities. There remains a necessity for secure channels of information exchange complying with statutory regulations, such as the Health Insurance Portability and Accountability Act (HIPAA).

Further, regular interaction between assisted living services provider, patients and family members of the patients is necessary for safe and effective delivery of care. However, face to face interactions is not always feasible due to many practical limitations posed by limited healthcare worker capacity, patient's ability to travel and/or busy schedule of the family members of the patient.

Furthermore, privacy rules, mandated by the Health Insurance Portability Accountability Act of 1996 (HIPAA), place additional responsibilities on assisted living services providers and/or health care providers to regulate access to patient health information. Therefore, it is incumbent upon nursing care facilities to secure authorization prior to releasing or disseminating private information.

In addition, conversations between the assisted living services provider, the patient and/or the family members of the patient may not fetch desired results as healthcare workers typically use medical jargon, and most of the patients and the family members of the patients are unaware of technical terms.

Also, in some related arts, the family members and friends of the patient contacts the assisted living services providers for information or updates. However, interacting with the right staff member of the assisted living services provider, over the phone can be difficult because of various administrative protocols in the assisted living services provider

Further, when a patient is admitted to an assisted living services facility, it becomes a cumbersome task for family and friends of the patient to be kept informed of the patient's health and day to day activities owing to the busy lifestyles of friends and family of the patient.

Further, it may be inconvenient for the assisted living services to provide information to the family and friends of the person about the person's health on a regular basis because of the demands involved with operating the assisted living services facility. Staff of the assisted living service provider typically do not have time to notify all the family and friends of the person because they spend most of their time tending to the needs of the person.

Some related arts provide updates to family members and friends of a patient of an assisted living facility. However, health or medical data of the patient may be stored in multiple unrelated data repositories. For example, the assisted living facility may have a separate database, while health data of the patient may be stored in an Electronic Medical Record (EMR) database. Therefore, the family members and friends of the patient may not have access to all the health related data.

It may therefore be beneficial to use secure messaging techniques for communicating the personal healthcare data of the patient of the assisted living services provider with family members and friends of the patient. Secure messaging is a server based approach to protect sensitive data when shared with external devices or accounts. Secure messaging also provides compliance with industry regulations, such as the Health Insurance Portability and Accountability Act (HIPAA), Gramm-Leach-Bliley Act (GLBA), and the like. Secure messaging works as an online service. A subscriber of the secure messaging service authenticates his/her identity by an enrollment process. Further, authentication can be done by an administrator who verifies the relation between the patient and the subscriber. Thereafter, the subscriber logs into an account by entering a username and a password similar to a web-based email account. Additional authentication methods, such as One-Time Password (OTP), biometric authentication, device based authentication, and the like, may also be utilized to authenticate the subscriber.

It may also be beneficial to provide system and methods to provide one to one interactions between the assisted living services providers, the patient and/or the family and friends of the patient.

It may further be beneficial to provide systems and methods for creating a communication network between a particular concerned department within the assisted living services provider, the patient, and the family and friends of the patient.

It may therefore be beneficial to provide systems and methods for presenting the medical jargon, involved in the healthcare of the patient, in a simplified and easily understandable form so that the patient, and the family and friends of the patient, with a non-technical background, may easily understand the health condition of the patient.

It may further be beneficial to provide systems and methods to notify the family and friends of the patient about the patient's day to day activity. Subsequently, it may be beneficial to provide systems and methods for tracking the health of the patient and inform the same to the family and friends of the patient on a regular basis. It may also be beneficial to provide systems and methods for tracking the healthcare data and updating the healthcare data in the patient records stored on a database.

It may therefore be beneficial to provide systems and methods for storing the healthcare data from one or more disparate data sources in a local) data base in accordance with a standardized format. It may further be beneficial to provide the systems and methods to retrieve data from the database and provide updates to the family members of the patient via a user interface.

Some embodiments of the disclosed subject matter are directed to systems and methods that facilitates exchange of massages between an assisted living service provides and a plurality of subscribers by using an authentication module.

Some embodiments are directed to a method of exchanging messages between an assisted living service provider and one or more subscribers. The method includes retrieving, by a server, data corresponding to a client of the assisted living service provider from one or more medical record databases. The method further includes transforming, by the server, the retrieved data in accordance with a predefined format. The method also includes storing the transformed data in a local database communicably coupled to the server. The method further includes sending one or more messages to one or more subscriber devices, the one or more messages including at least one of a health status, an activity status, an assistance status, a nutrition status and a medication status of the client.

Some embodiments are directed to a method of exchanging messages between an assisted living service provider and one or more subscribers. The method includes retrieving, by a server, data corresponding to a client of the assisted living service provider from one or more medical record databases and transforming, by the server, the data retrieved from one or more medical record databases in accordance with a predefined format. The method also includes storing the transformed data in a local database communicably coupled to the server. The method further includes sending notifications to one or more subscriber devices and receiving responses to the notifications. The method further includes authenticating one or more subscribers based on the responses received from the one or more subscriber devices. The method also includes sending one or more messages to the one or more subscriber devices corresponding to the one or more authenticated subscribers. The one or more messages includes at least one of a health status, an activity status, an assistance status, a nutrition status and a medication status of the client.

Yet other embodiments are directed to a system for exchanging messages between an assisted living service provider and one or more subscribers. The system includes a server communicably coupled to one or more medical record databases and one or more subscriber devices. The system further includes an application installed on the one or more subscriber devices. The server is configured to receive a subscriber profile from each of the plurality of subscribers, retrieve data corresponding to a client of the assisted living service provider from the one or more medical record databases, transform the data retrieved from one or more medical record databases in accordance with a predefined format, store the transformed data in a local database communicably coupled to the server, and send one or more messages to the one or more subscriber devices. The one or more messages includes at least one of a health status, an activity status, an assistance status, a nutrition status and a medication status of the client. The application, installed on the one or more subscriber devices, is configured to display the one or more messages on a user interface.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed and it does not limit the scope of the disclosed subject matter which is defined by the claims. Included in the drawings are the following figures:

FIG. 1 illustrates an exemplary system for exchanging data between a group of subscribers and medical record databases associated with assisted/skilled care facilities in accordance with the disclosed subject matter.

FIG. 2 illustrates a detailed view of the exemplary system associated with assisted care facilities in accordance with the disclosed subject matter.

FIGS. 3A, 3B and 3C are schematics of a user interface shown on a subscriber device in accordance with the disclosed subject matter.

FIG. 4 is a flowchart of an exemplary method of exchanging data in accordance with the disclosed subject matter.

FIG. 5 is a flowchart of an exemplary method of exchanging data in accordance with the disclosed subject matter.

FIG. 6 is a flowchart of an exemplary method of exchanging data in accordance with the disclosed subject matter.

FIG. 7 is a computer system that can be used to implement various exemplary embodiments of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

### I. SERVER ENVIRONMENT

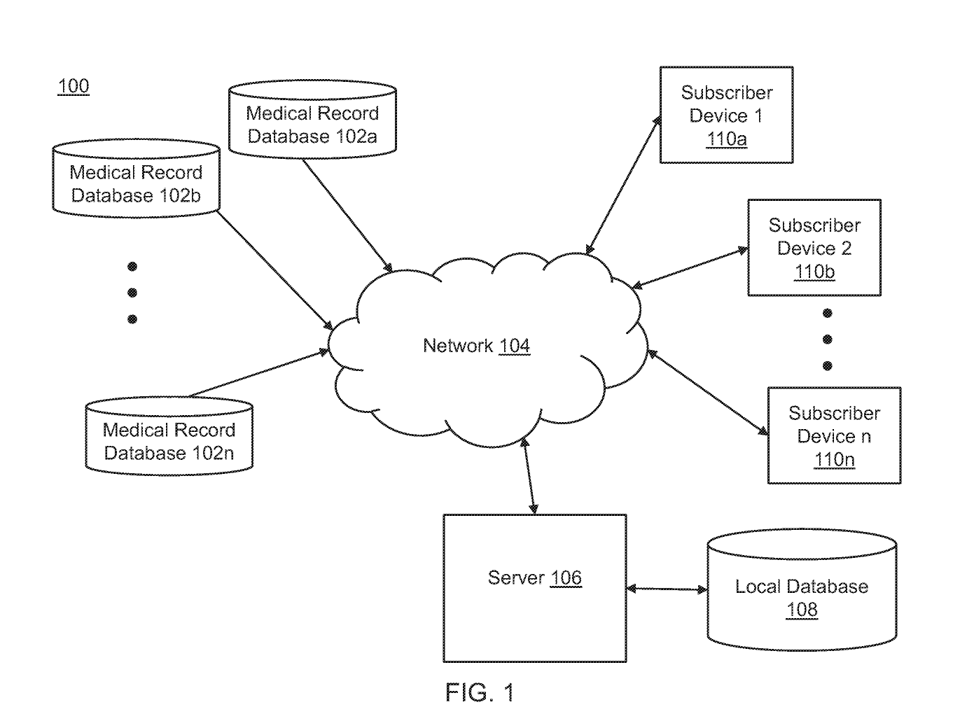

FIG. 1A is an illustration of a system 100 in accordance with the disclosed subject matter. The system 100 is configured to communicate and manage healthcare data of a patient. Specifically, the system 100 facilitates exchange of healthcare data between medical record databases 102a to 102n and a plurality of subscriber devices 110a to 110n through a server 106 communicably coupled to a local database 108.

The medical record databases 102a to 102n are hereinafter collectively referred to as “the medical record databases 102”. The medical record databases 102 can be communicably coupled to at least one of a hospital, nursing facility, assisted care facility and the like. Typically, the medical histories and related healthcare data of patients are stored on the medical record databases 102 and are only accessible to the patients and to any individual or service designated by the patient. The medical record databases 102 can include an Electronic Medical Record (EMR) database. The patient may have engaged the services of various healthcare institutions, such as a hospital, and an assisted care facility previously, and the medical history and related healthcare data of the patient can be uploaded to any of the medical record databases 102 which may include the EMR database. The patient can be enrolled to an assisted care facility and can authorize the assisted care facility to access his/her medical records from the medical record databases 102, including the EMR database. The server 106 is maintained by the administration of the assisted care facility. The server 106 retrieves the required healthcare data from the medical record databases 102, including the EMR database through the network 104, and stores the retrieved data in the local database 108.

The plurality of subscriber devices 110a to 110n are hereinafter collectively referred to as “the subscriber devices 110”. A subscriber can be any individual, such as a guardian, family member or a friend, or corporations, such as a health insurance provider and the like, that may be designated by the patient to receive periodic updates from the assisted care facility regarding the status of the patient. The server 106 extracts the required healthcare data from the local database 108 and communicates the retrieved healthcare data to the subscriber devices 110 via the network 104. In some other embodiments, the server 106 extracts the medical data from the medical record databases 102 and directly communicates the retrieved healthcare data to the subscriber device 110 via the network 104, and then stores the retrieved healthcare data into the local database 108. In other embodiments, the server 106 may also additionally communicate healthcare data, messages or notifications to an email account associated with each subscriber.

The medical record databases 102 are intended to include healthcare data related to visits by the patients to various healthcare facilities, hospitals, other assisted care facilities, clinics, medical service providers, health centers, clinics, nursing homes, senior care providers, infirmaries, retirement homes, old age homes, and the like. In fact, embodiments are intended to cover any type of medical record database that include healthcare data from sources that can create healthcare data of a patient and store the healthcare data. Embodiments are also intended to include any central data repository of healthcare data, such as the EMR database. The healthcare data is intended to be any type of healthcare informatics, biomedical informatics, nursing informatics, clinical informatics, and the like. The healthcare data of a patient is confidential data related to the patient's health which includes all information related to a patient's medical history, diagnostic images, test results, various reports and daily activity reports. The healthcare data can be transformed to a predefined format as described below.

The server 106 can transform the data retrieved from the medical record databases 102 in accordance with the predefined format and populate the tables of the local database 108 with the transformed data. The server 106 can implement various algorithms to convert or transform the retrieved data including, but not limited to, statistical methods, probabilistic methods, and so forth. In case any data does not include an entry corresponding to any of the tables, the tables are left blank. Therefore, the local database 108 may allow standardization of data from different data sources, and enable quick display of the stored data in accordance with the predefined format.

In some embodiments, the local database 108 may be a relational database and/or an object-relational database. The local database 108 organizes data into one or more tables of columns and rows with a key identifying a row and/or column in each table. The keys for each row and/or column are used to define logical connections (called relationships) among the tables. The data residing in the tables can be manipulated such that the data is displayed on the subscriber devices 110 in a legible format. In some embodiments, the data can be displayed on the subscriber devices 110 in the form of messages that can be easily understood by the subscribers. The data stored in multiple tables on the local database 108 is retrieved from any or a combination of the medical record databases 102.

In other embodiments, the local database 108 can be an object-relational database with an emphasis on extensibility and standards-compliance. Specifically, the local database 108 can implement the standards related to structured query language (SQL) protocols. The local database 108 allows for the retrieval of data stored on it at the request of the server 106 or other software applications through the server 106. In some embodiments, the local database 108 implements the PostgreSQL standard and can handle workloads ranging from small single-machine applications to large network applications with multiple users.

In some embodiments, the local database 108 may be stored on a memory that is part of the server 106. In other embodiments, the local database 108 may be stored on a cloud based storage system that is communicably coupled to the server 106 via the network 104.

Further, access to the healthcare data comes under the purview of legal statutes that cover various privacy, ethical and operational issues that invariably arise when electronic tools, wireless communication, digital information and storage media are used in health care delivery. Such statutes deal with the circumstances under which health-related data and healthcare records can be shared to third parties to support and enhance patient care. Therefore, all the healthcare data has to be communicated through a network 104 over a highly secure messaging protocol. In the illustrated embodiment, the network 104 communicably couples the medical record databases 102, the server 106 and the subscriber devices 110 to each other.

The network 104 may include a data network such as, but not restricted to, the Internet, local area network (LAN), wide area network (WAN), metropolitan area network (MAN), etc. In certain embodiments, the network 104 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS) etc. In some embodiments, the network 104 may include or otherwise cover networks or subnetworks, each of which may include, for example, a wired or wireless data pathway. The network 104 may include a circuit-switched voice network, a packet-switched data network, or any other network capable for carrying electronic communications. For example, the network may include networks based on the Internet protocol (IP) or asynchronous transfer mode (ATM), and may support voice usage, for example, VoIP, Voice-over-ATM, or other comparable protocols used for voice data communications. In one implementation, the network includes a cellular telephone network configured to enable exchange of text or SMS messages.

Examples of the network 104 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the medical record databases 102, the server 106, the local database 108 and the subscriber devices 110 with each other.

The transfer of health data via the network 104 takes place over a highly secured messaging protocol in order to protect the confidential data related to patient's health. Secure messaging is server-based approach to protect sensitive data when sent over the network 104. Secure messaging may have different types of delivery such as secured web interface, Secure/Multipurpose Internet Mail Extension (S/MIME) encrypted communication, Pretty Good Privacy (PGP) encrypted communication, Transport Layer Security secured connection to email domains.

### II. HEALTHCARE DATA MANAGEMENT

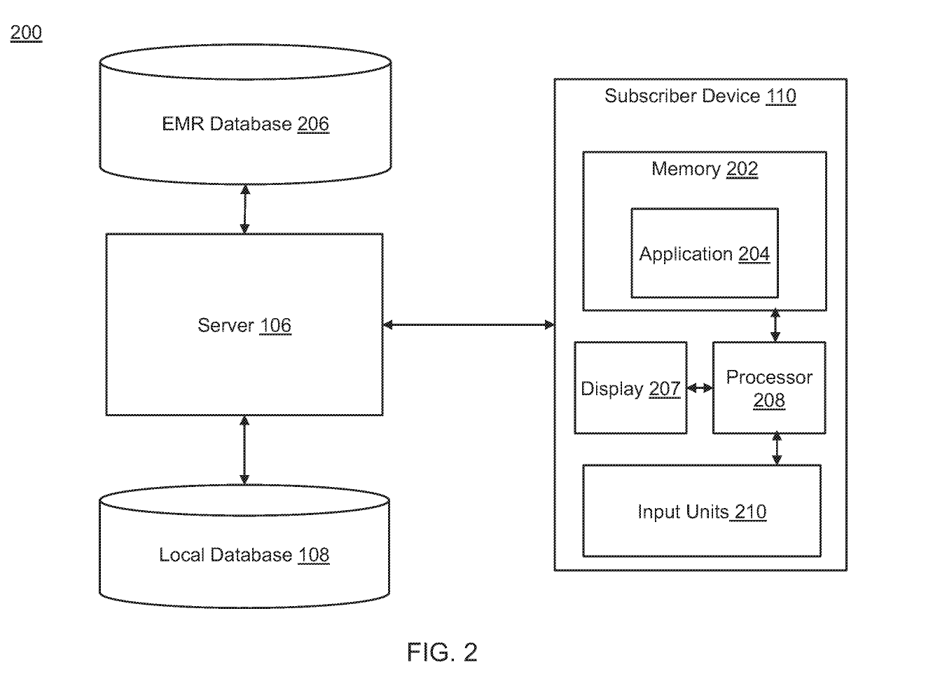

FIG. 2 illustrates a system 200 that provides an exemplary embodiment in accordance with the disclosed subject matter. The system 200 includes the server 106 communicably coupled to the local database 108. The server 106 is maintained and operated by the assisted care facility or a third party provider designated by the assisted care facility. As seen in FIG. 1, the healthcare data is extracted from an EMR database 206 when a patient or client designates the assisted care facility to access his/her healthcare data from the EMR database 206 at the time of enrollment. Accordingly, the healthcare data is retrieved by the server 106.

The electronic medical record (EMR) or electronic health record (EHR) is a systematic collection of patient's health information or healthcare data stored in a digital format. The EMR database 206 may be, but not restricted to, an online transaction processing (OLTP) database, a SQL server database, a Sybase, etc. The EMR database is a universal and secure repository of healthcare information of various individuals. It is compliant with legal statutes as the Health Insurance Portability and Accountability Act (HIPAA) 1996, which specifies who can access or retrieve a patient's medical records. This statute set limits on the use and release of medical records, and established a series of privacy standards for health care providers.

In some embodiments, the server 106 may be hosted on a platform that is compliant with various statutory regulations, such as the Health Insurance Portability and Accountability Act (HIPAA). In an example, the server 106 may be hosted on Aptible. Further, all communication with the server 106 may be through a secure Virtual Private Network (VPN) to ensure security and confidentiality of data.

The subscriber device 110 is intended to include any electronic device, such as desktop computers, portable computers, smartphones, tablet computers, wearable devices, personal digital assistant (PDA), and the like, associated with a subscriber designated by the patient at the time of enrollment. The subscriber can be a family member, a friend, a guardian or any other subscriber closely associated with the patient. At the time enrollment in the assisted care facility, administrative protocols may be put in place to receive subscriber profiles corresponding to each subscriber. Subscriber profiles includes at least one of communication information, such as phone numbers, electronic mail addresses, postal addresses and the like, biographical data or any other information that identifies the subscriber. Subscriber profiles can be stored on the local database 108 while linking them to the patient's medical records that are retrieved from the EMR database 206. Accordingly, the server 106 sends a notification to the subscriber device 110. In some embodiments, the notification can be an activation link sent to the electronic mail address provided as part of the subscriber profile. In some other embodiments, the notification can be a secure message with a one-time-password that may be active for a period of time. The secure message can be sent as a text or a notification on a mobile application displayed on a smartphone. The notification directs the subscriber associated with the subscriber to perform an action that enables the subscriber to send a response to the server 106. The action can include clicking an activation link sent in a text, electronic mail message or a mobile application notification or entering a one-time-password in a web page hosted by the server 106, the link address to which is provided in the notification.

In some embodiments, the notification can include or be encrypted by a security token. The security token can be at least one of a digital signature, cryptographic keys, a configuration file comprising a username and a password or a personal identification number. In some embodiments, the response can include entering the username and password or the personal identification number at the user interface of an application 204 hosted by the server 106. The application 204 can also be a software application installed on the subscriber device 110. In some embodiments, viewing the notification on the user interface of the application 204 at the subscriber device 110 can automatically send a response to the server 106.

The subscriber device 110 can include a memory 202, a display unit 207, a processor 208 and one or more input units 210. The application 204 can be installed on the subscriber device 110 and stored on the memory 202. A user interface of the application 204 can be displayed on the display unit 207. The display unit 207 can include, but not limited to, a Cathode Ray Tube (CRT) display, a Liquid Crystal Display (LCD), a Light Emitting Diode (LED) display, and the like. The input units 210 can include a haptic interface, a keyboard, voice recognition and the like. In some embodiments, the application 204 can be a web application hosted by the server 106 and viewed on a web browser through the network 104. In other embodiments, the application 204 can be a software application installed on the subscriber device 110 and uses the network 104 to receive notifications from the server 106 and send responses to the server 106. The software application can work in conjunction with the server 106 to perform various operations. Further, the application 204 can include a set of computer readable instructions that upon execution by the processor 208 of the subscriber device 110 perform various operations associated with the application 204.

The subscriber is authenticated based on the response sent to the server 106. In some embodiments, multiple subscribers associated with the patient or client can be sent notifications and based on responses received by the server 106 from each of them, the subscribers are authenticated to receive information regarding the patient's welfare. The server 106 can create a group of authenticated subscribers, with each authenticated subscriber being authorized to receive information related to the client or patient of the assisted living service provider.

Subsequently, each authenticated subscriber receives one or more messages from the server 106. In some embodiments, the messages can be encrypted using a security token. The one or more messages can be decrypted by the application 204 installed on the subscriber device 110. The one or more messages can include at least one of a health status, an activity status, an assistance status, a nutrition status and a medication status of the client. The health status may include information about the health of the client, for example, whether the health status is poor, good or average. The activity status can include information about any physical or group activity performed by the client. The assistance status may include a level of assistance required by the client to perform routine activities. The nutrition status may include the number of meals, nutritional information, the type of meals and an amount of food consumed by the client. The medication status can include details of medicines consumed by the client including dosage and periodicity of consumption. Other types of information that can be included the messages can include diagnostic information of the client, billing information, emergency notifications, and the like.

The one or more messages from the server 106 can be displayed on the display unit 207. Further, the messages can be displayed on the user interface of the application 204 installed on the subscriber device 110. In some embodiments, the messages can be displayed in form of a newsfeed. The messages can also be displayed as periodic updates (e.g., daily, hourly etc.). The messages can also be displayed as per preferences of the subscriber. For example, the messages can be displayed at a specific time of the day chosen by the subscriber. The messages can also be displayed aperiodically in accordance with an event trigger detected by the server 106. The event trigger can be an emergency notification. The user interface of the application 204 will be described in detail hereinafter. Further, the newsfeed presentation enables a subscriber to view updates on the user interface 300 in a sequential manner. The subscriber can scroll up or down to find a particular update on the user interface 300. Further, new messages or updates on the user interface 300 can trigger an alarm on the subscriber device 110. The alarm can include, but not limited to, an audible alarm, a vibration of the subscriber device 110, flashing of the display unit 207 and the like. The alarm can be triggered in case the message is an emergency notification that requires immediate attention of the subscriber.

Additionally, the message can be a reply to a query made by the subscriber through the application 204. The query can be directed to one or more healthcare professionals concerned with the care of the client. The query can include questions regarding the messages sent to the application 204, independent questions concerning the client, and/or questions related to obtaining extra information on any specific issue concerning the client. The server 106 can parse the query and identify an intended recipient of the query. The server 106 can then route the query to the intended recipient. In some embodiments, the subscriber may provide details regarding the recipient of the query. In some other embodiments, the recipient can be identified based on appropriate parsing of the query such as certain preset keywords present in the query.

The local database 108 can include a list of healthcare professionals associated with the client. Communication information, such as email address, telephone number, and the like, may also be present on the local database 108. Upon identification of the intended recipient, the server 106 may extract communication information of the intended recipient from the local database 108 and route the query to the intended recipient based on the available communication information. The intended recipient may receive an email, a text message, any other notification that includes the query. Upon receiving an answer from the intended recipient in the form of an email or any electronic message, the server 106 may send the answer to the application 204 for display on the user interface.

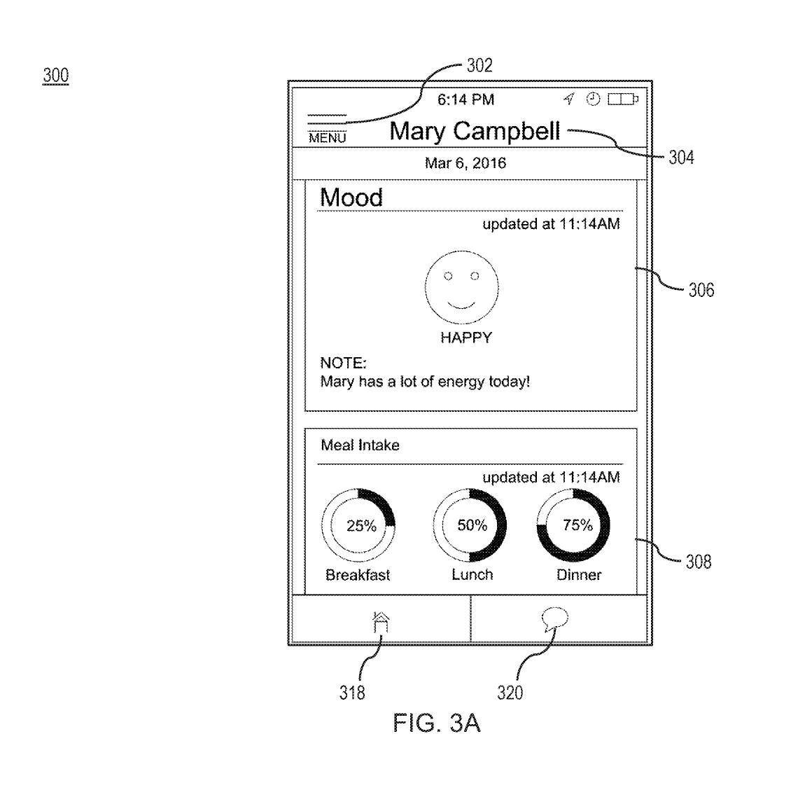

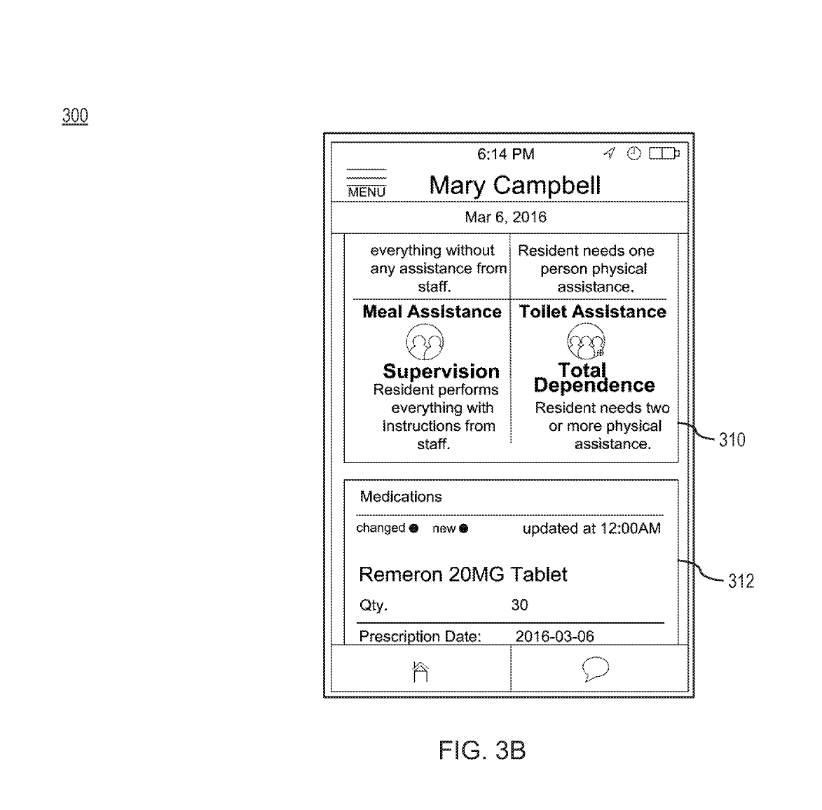

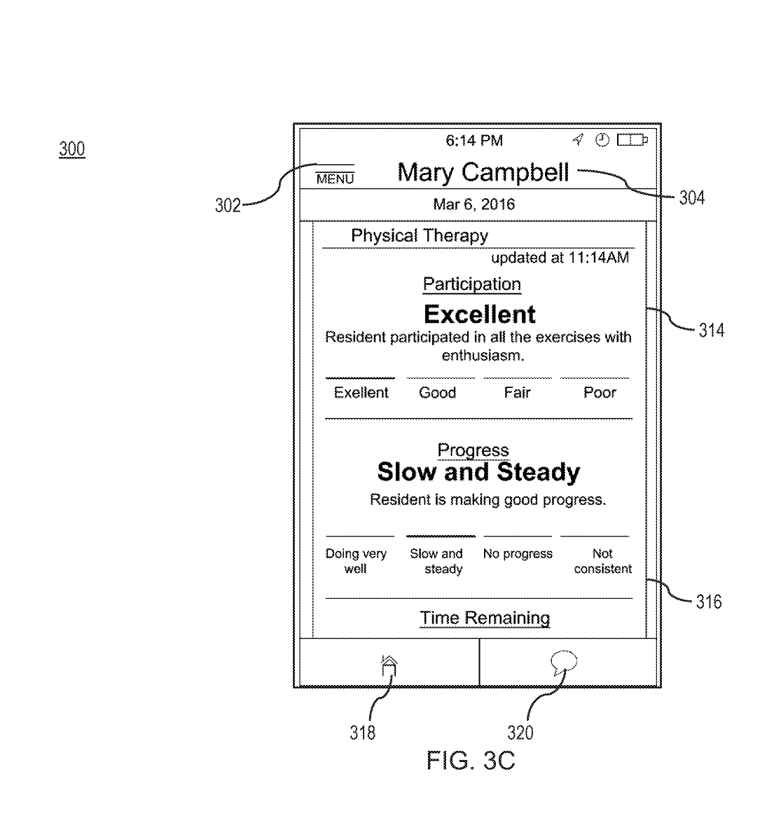

FIGS. 3A, 3B and 3C illustrates an exemplary embodiment of a user interface 300 presented on the subscriber device 110. The user interface 300 can be communicably coupled to the server 106 and the local database 108 shown in FIG. 2. The user interface 300 can be part of the application 204 installed on the subscriber device 110. Further, the application 204 can be stored on the memory 202. The user interface 300 can include various display panels displaying the messages from the server 106 regarding the welfare of the client or patient. The user interface 300 can also include navigation buttons.

Referring to FIG. 3A, the display panels include, but are not limited to, a name panel 304, a mood panel 306 and a meal panel 308. The name panel 304 displays the name of the client or the patient. The mood panel 306 displays a mood or an emotional status of client, while the meal panel 308 displays the nutrition status of the client. The navigation buttons include a menu button 302, a home button 318 and a query button 320. Clicking the menu button 302 displays a popup menu or a separate dialog box with a menu. The menu can include, but not limited to, options for changing the display options, the configuration of display panels, authentication information, and also options to unsubscribe or delete the subscription. Clicking the home button 318 can direct the subscriber to a starting page that can provide a variety of options such as navigating between different display panels, analyze data being sent from the server 106 and the like.

Referring to FIG. 3B, the user interface can include an assistance panel 310 and a medication panel 312. The assistance panel 310 displays the assistance status of the client, while the medication panel 312 displays the medication status of the client. FIG. 3C shows the user interface 300 to include a physical therapy panel 314 and a health monitor 316. The physical therapy panel 314 displays the activity status of the client, while the health monitor 316 displays the health status of the client. The user interface is not limited to the display panels described in FIGS. 3A, 3B and 3C and can include different display panels for different types of messages being sent to the application 204.

The query button 314, as shown in FIG. 3A, is used by the subscriber to send queries to an appropriate healthcare professional concerned with the welfare of the client. Clicking the query button 314 can open a new dialog box wherein the query can be entered by the subscriber. The query can be directed to one or more healthcare professionals concerned with the care of the client. The query can include questions regarding the messages sent to the application 204, independent questions concerning the client, and/or questions related to obtaining extra information on any specific issue concerning the client. The query can be parsed to identify the appropriate healthcare professional. In some embodiments, the subscriber may provide details regarding the intended recipient of the query. In some other embodiments, the recipient can be identified based on appropriate parsing of the query. Replies from the recipient is sent as a message and presented on the user interface 300 on any of the display panels 304 to 316. In some embodiments, the reply may be presented on a separate dialog box.

The various display panels are also periodically updated with messages from the server 106 that include at least one of a health status, an activity status, an assistance status, a nutrition status and a medication status of the client.

In some embodiments, the display panels 304 to 316 are presented in the form of a news feed. Each panel can be independently updated by the messages received from the server 106 through the use of asynchronous java scripts and extensible markup language. In yet other embodiments, emergency notifications from the assisted living service provider can be sent as messages to the user interface 300.

The messages sent by the server 106 are a combination of data provided by a healthcare professional at the assisted living service provider catering to the needs of the client, and the transformed data that is originally retrieved from the EMR database and stored on the local database 108. For example, the local database 108 can store data relating to the diabetes medications from the client's or patient's past medical history. This data is extracted from the EMR database 206. Any graphical or statistical analyses from the retrieved data is done and the data is transformed to include such analytical evaluations. The retrieved data along with the analyses is stored in one or more tables of columns and rows with a key identifying a row and/or column in each table. The keys for each row and/or column are used to define logical connections (called relationships) among the tables. Once the client is admitted to the assisted living service provider, the client is periodically evaluated by a healthcare professional of the healthcare facility for any new complications in the context of the prevalent diabetes. Reports arising out of the evaluations are sent as messages by the server 106 and presented on the user interface 300 through the display panels 304 to 316. Changes in medication are also reported and accordingly presented on the user interface 300. Accordingly, any updates to the transformed data stored in the local database 108 are also displayed accordingly on the user interface 300 with appropriate messages being sent by the server 106 to the application 204.

### III. EXEMPLARY EMBODIMENTS

Some embodiments are directed to the system 200 for exchanging messages between the server 106 and the subscribers via the subscriber devices 110. The server 106 is communicably coupled to the EMR database 206. When a client or patient enrolls into the assisted living service provider, the assisted living service provider is authorized, via the server 106, to retrieve healthcare records associated with the client from the EMR database 206. This data is transformed to a predefined format and stored on the local database 108. The client provides a list of subscribers who may be family members, friends or any corporation, including any health insurance provider, to the assisted living service provider. The subscriber profiles, including connection information corresponding to the subscriber, are received at the server 106. The subscribers are sent notifications by the server 106 that enable authenticating the identity of the subscriber with the notification including a security token. The subscriber device 110 receives the notification and via the application 204 installed on the subscriber device 110, decrypts the notification and sends a response to the server 106, thereby authenticating the subscriber. Multiple authenticated subscribers are grouped and receive messages pertaining to the at least one of a health status, an activity status, an assistance status, a nutrition status and a medication status of the client. All the messages are sent to the subscriber group and presented on each subscriber device 110 through the user interface 300. The user interface 300 is a part of the application 204 installed on the subscriber device 110. In some embodiments, the notifications, the messages, and responses are exchanged between the server 106 and the subscriber device 110 through the SendGrid platform. The subscriber authentication can be facilitated through object oriented programming design and Ruby classes. Further, the application 204 can utilize web frameworks, such as Rails or mobile application frameworks such as Ionic, so that the application 204 can be deployed over the network 104 and installed on the subscriber devices 110.

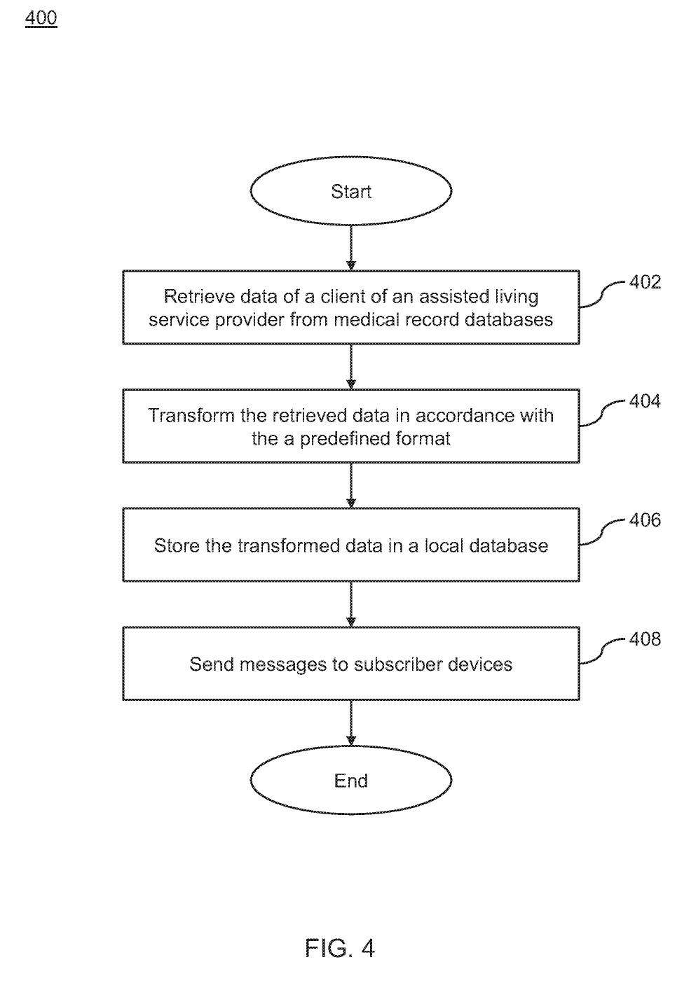

FIG. 4 illustrates a method 400 of exchanging data between an assisted living service provider and one or more subscribers, each subscriber being associated with the subscriber device 110, in accordance with the disclosed subject matter. This flowchart is merely provided for exemplary purposes, and embodiments are intended to include or otherwise cover any methods or procedures for exchanging data.

In accordance with FIG. 4, at step 402, the server 106 retrieves data corresponding to the client from one or more medical record databases 102 that includes the EMR database 206. At step 404, the retrieved data is transformed in accordance with a predefined format. Any graphical or statistical analyses is performed on the retrieved data and the retrieved data is transformed to include such analytical evaluations. The retrieved data along with the analyses is stored in one or more tables of columns and rows with a key identifying a row and/or column in each table. The keys for each row and/or column are used to define logical connections (called relationships) among the tables. Once the client is admitted to the assisted living service provider, the client is periodically evaluated by a healthcare professional of the healthcare facility for any new complications in the context of the existing ailments. At step 408, reports arising out of the evaluations are sent as messages by the server 106 and presented on the user interface 300 through the display panels 304 to 316. Changes in medication are also reported and accordingly presented on the user interface 300. Further, emergency notifications can also be sent to the user interface 300. Daily updates on the activity and food intake of the client are also presented on the user interface 300.

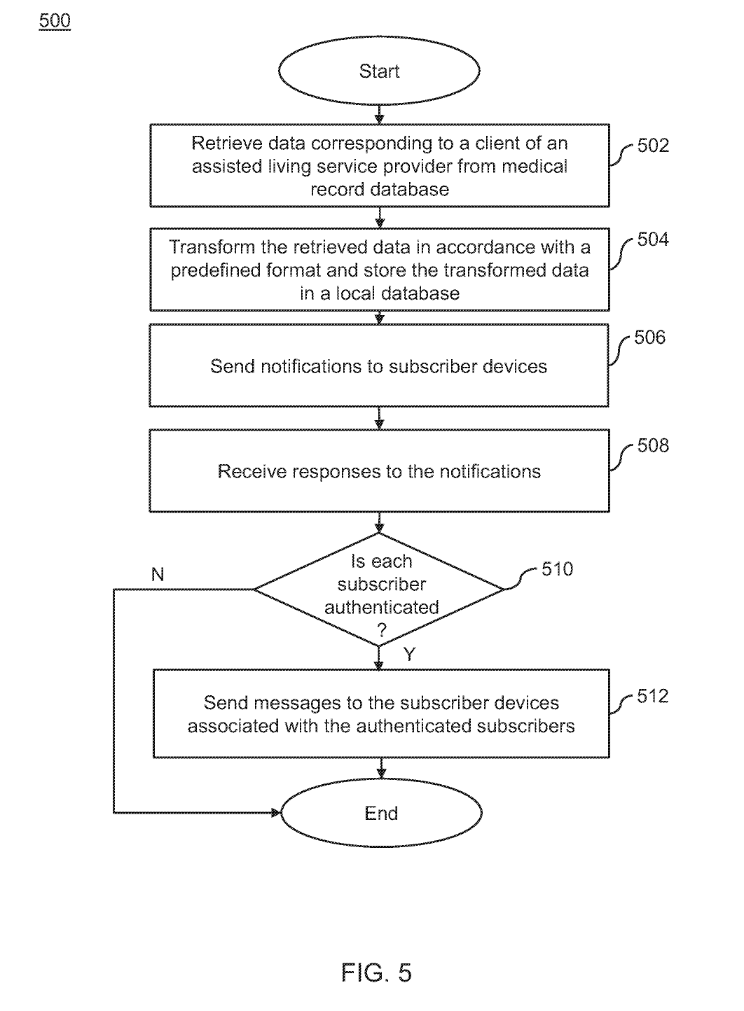

FIG. 5 is a flowchart of a method 500 for exchanging messages between an assisted living service provider and one or more subscribers, each subscriber being associated with the subscriber device 110.

At step 502, the server 106 retrieves data corresponding to the client from the EMR database 206. At step 504, the retrieved data is transformed in accordance with a predefined format. Any graphical or statistical analyses is performed on the retrieved data and the data is transformed to include such analytical evaluations. The retrieved data along with the analyses is stored in one or more tables of columns and rows with a key identifying a row and/or column in each table. The keys for each row and/or column are used to define logical connections (called relationships) among the tables. Once the client is admitted to the assisted living service provider, the client is periodically evaluated by a healthcare professional of the healthcare facility for any new complications in the context of any prevailing ailments. At the time of enrolment, the client provides a list of subscribers to the assisted living care facility. The subscriber can be a family member, a friend, a guardian or any other subscriber closely associated with the patient. At the time enrollment in the assisted care facility, administrative protocols may be put in place to receive subscriber profiles corresponding to each subscriber. Subscriber profiles includes at least one of communication information, such as phone numbers, electronic mail addresses, postal addresses and the like, biographical data or any other information that identifies the subscriber. Subscriber profiles can be stored on the local database 108 while linking them to the patient's medical records that are retrieved from the EMR database 206.

At step 506, the server 106 sends a notification to the subscriber device 110. In some embodiments, the notification can be an activation link sent to the electronic mail address provided as part of the subscriber profile. In some other embodiments, the notification can be a secure message with a one-time-password that may be active for a period of time. The secure message can be sent as a text or a notification on a mobile application displayed on a smartphone. The notification directs the subscriber associated with the subscriber device 110 to perform an action that permits the subscriber to send a response to the server 106. The action can include clicking an activation link sent in a text, electronic mail message or a mobile application notification or entering a one-time-password in a web page hosted by the server 106, the link address to which is provided in the notification. The notification can include or be encrypted by a security token. The security token can be at least one of a digital signature, cryptographic keys, a configuration file comprising a username and a password or a personal identification number. At step 508, a response to the notification is sent by the application 204 to the server 106. In some embodiments, the response can include entering the username and password or the personal identification number at the user interface 300 of the application 204 hosted by the server 106. Further, the application 204 can be a software application installed on the subscriber device 110. In some embodiments, viewing the notification on the user interface 300 of the application 204 can automatically send a response to the server 106.

Subsequently, at step 510, the subscriber is authenticated based on the response received. If the response is different from the expected response, the server 106 rejects the response. The subscriber is authenticated if the response matches an expected response. For example, if the response includes an incorrect password/username or an incorrect personal identification number that was provided as the security token in the notification, the server 106 rejects the response and bars the subscriber from accessing any information from the server 106. In some embodiments, the subscriber may be given a definite number of attempts to perform a successful authentication before the subscriber is permanently barred from exchanging any data with the server 106.

At step 512, reports arising out of the evaluations are sent as messages by the server 106 to the authenticated subscribers. The messages are presented on the user interface 300 of the application 204 installed on each subscriber device 110 corresponding to each authenticated subscriber. Changes in medication are also reported and accordingly presented on the user interface 300. Further, emergency notifications and any updates made to the transformed data can also be sent to the user interface 300. Daily updates on the activity and food intake of the client are also presented on the user interface 300.

Further, the subscriber can send queries related to the messages presented on the user interface 300. The query button 314 is used by the subscriber to send queries to an appropriate healthcare professional concerned with the welfare of the client. The query can be directed to one or more healthcare professionals concerned with the care of the client. The query can include questions regarding the messages sent to the application 204, independent questions concerning the client, and/or questions related to obtaining extra information on any specific issue concerning the client. The query can be parsed to identify an intended recipient or appropriate healthcare professional. In some embodiments, the subscriber may provide details regarding the intended recipient of the query. In some other embodiments, the recipient can be identified based on appropriate parsing of the query such as certain preset keywords present in the query. Replies from the recipient is sent as a message and presented on the user interface 300 on any of the display panels 304 to 316. In some embodiments, the reply may be presented on a separate dialog box.

Therefore, the method 500 can further include receiving a query from one or more of the subscriber devices 110, routing the query to the intended recipient of the assisted living care service provider, receiving an answer from the intended recipient, and sending the answer to the one or more subscriber devices 110.

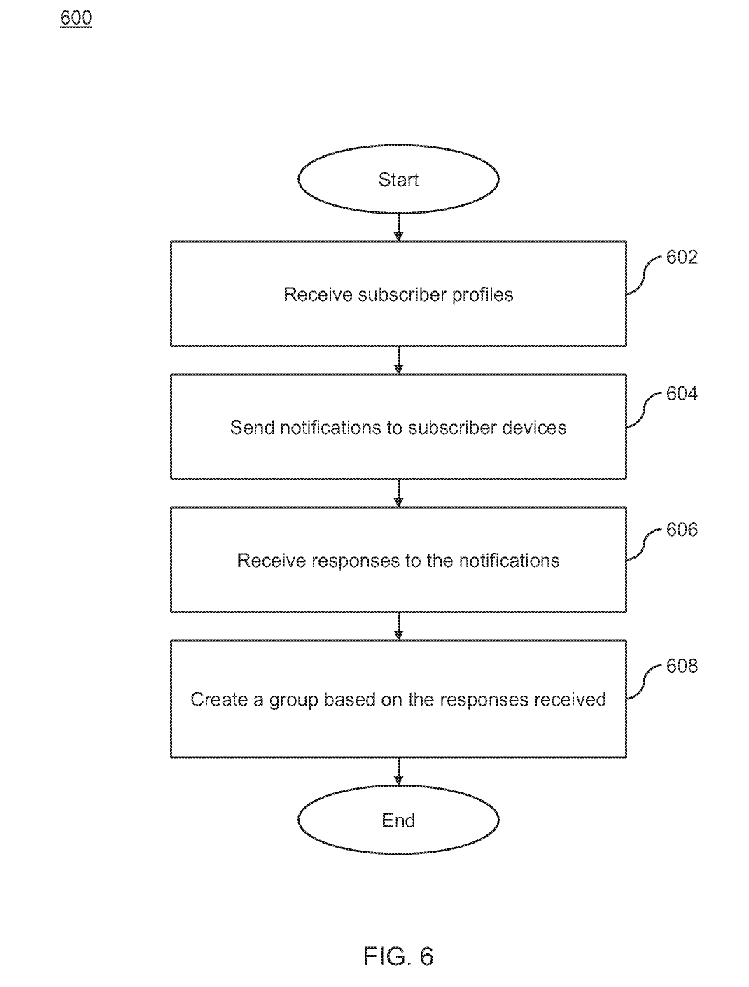

FIG. 6 illustrates the method 600 to create a group of authenticated subscribers. At the time of enrolment, the client provides a list of subscribers to the assisted living care facility. The subscriber can be a family member, a friend, a guardian or any other subscriber closely associated with the patient. At the time enrollment in the assisted care facility, administrative protocols may be put in place to receive subscriber profiles corresponding to each subscriber. Referring to FIG. 6, this is shown in step 602. Subscriber profiles includes at least one of communication information, such as phone numbers, electronic mail addresses, postal addresses and the like, biographical data or any other information that identifies the subscriber. Subscriber profiles can be stored on the local database 108 while linking them to the patient's medical records that are retrieved from the EMR database 206. At step 604, the server 106 sends a notification to the subscriber device 110. In some embodiments, the notification can be an activation link sent to the electronic mail address provided as part of the subscriber profile. In some other embodiments, the notification can be a secure message with a one-time-password that may be active for a period of time. The secure message can be sent as a text or a notification on a mobile application displayed on a smartphone. The notification directs the subscriber associated with the subscriber device 110 to perform an action that permits the subscriber to send a response to the server 106. The action can include clicking an activation link sent in a text, electronic mail message or a mobile application notification, or entering a one-time-password in a web page hosted by the server 106, the link address to which is provided in the notification. The notification can include or be encrypted by a security token. The security token can be at least one of a digital signature, cryptographic keys, a configuration file comprising a username and a password or a personal identification number. At step 606, a response to the notification is sent by the application 204 to the server 106. In some embodiments, the response can include entering the username and password or the personal identification number at the user interface 300 of the application 204 hosted by the server 106. In some embodiments, viewing the notification on the user interface 300 of the application 204 at the subscriber device 110 can automatically send a response to the server 106.

Subsequently, the subscriber is authenticated based on the response received. If the response is different from the expected response, the server 106 rejects the response. The subscriber is authenticated if the response matches an expected response. For example, if the response includes an incorrect password/username or an incorrect personal identification number that was provided as the security token in the notification, the server 106 rejects the response and bars the subscriber from accessing any information from the server 106. In some embodiments, the subscriber may be given a definite number of attempts to perform a successful authentication before the subscriber is permanently barred from exchanging any data with the server 106.

At step 608, the server 106 combines the authenticated subscribers into a group. Messages concerning the client are sent as a common message to the group of authenticated subscribers.

### IV. OTHER EXEMPLARY EMBODIMENTS

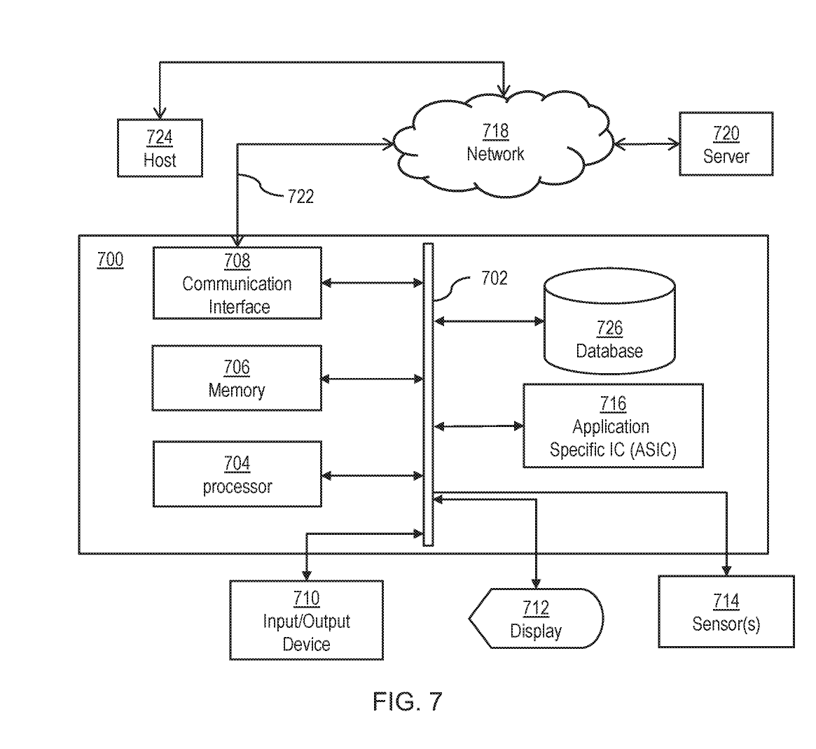

FIG. 7 illustrates a computer system 700 upon which the operation of the subscriber device 110, the server 106, the local database 108 and one or more of the subscriber devices 110 may be implemented. Although, the computer system 700 is depicted with respect to a particular device or equipment, it is contemplated that other devices or equipment (e.g., network elements, servers, etc.) within FIG. 7 can deploy the illustrated hardware and components of system. The computer system 700 is programmed (e.g., via computer program code or instructions) to retrieve data from the medical record databases 102 described herein and includes a communication mechanism such as a bus 702 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. The computer system 700, or a portion thereof, constitutes a means for performing one or more steps retrieving data from one or more medical record databases 102.

A bus 702 includes one or more parallel conductors of information so that information is transferred quickly among devices coupled to the bus 702. A processor 704 for processing information are coupled with the bus 702.

The processor 704 performs a set of operations on information as specified by an end-user. Further, the processor 704 can generate the response to the notifications sent by the server 106. The computer program code is a set of instructions or statements providing instructions for the operation of the processor 704 and/or the computer system 700 to perform specified functions. The code, for example, may be written in a computer programming language that is compiled into a native instruction set of the processor 704. The code may also be written directly using the native instruction set (e.g., machine language). The set of operations include bringing information in from the bus 702 and placing information on the bus 702. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 704, such as a sequence of operation codes, constitute processor instructions, also called computer system instructions or, simply, computer instructions. The processor 704 may be implemented as mechanical, electrical, magnetic, optical, chemical, or quantum components, among others, alone or in combination.

The computer system 700 also includes a memory 706 coupled to the bus 702. The memory 706, such as a Random Access Memory (RAM) or any other dynamic storage device, stores information including processor instructions for storing information and instructions to be executed by the processor 704. The dynamic memory 706 allows information stored therein to be changed by the computer system 700. RAM allows a unit of information stored at a location called a memory address to be stored and retrieved independently of information at neighboring addresses. The memory 706 is also used by the processor 704 to store temporary values during execution of processor instructions. The computer system 700 also includes a Read Only Memory (ROM) or any other static storage device coupled to the bus 702 for storing static information, including instructions, that is not changed by the computer system 700. Some memory is composed of volatile storage that loses the information stored thereon when power is lost. Also coupled to the bus 702 is a non-volatile (persistent) storage device 708, such as a magnetic disk, a solid state disk, optical disk or flash card, for storing information, including instructions, that persists even when the computer system 700 is turned off or otherwise loses power.

Information is provided to the bus 702 for use by the processor 704 from an external input device 710, such as a keyboard containing alphanumeric keys operated by a human user, a microphone, an Infrared (IR) remote control, a joystick, a game pad, a stylus pen, a touch screen, or a sensor. The sensor detects conditions in its vicinity and transforms those detections into physical expression compatible with the measurable phenomenon used to represent information in the computer system 700. Other external devices coupled to the bus 702, used primarily for interacting with humans, include a display 712, such as a Cathode Ray Tube (CRT), a Liquid Crystal Display (LCD), a Light Emitting Diode (LED) display, an organic LED (OLED) display, active matrix display, Electrophoretic Display (EPD), a plasma screen, or a printer for presenting text or images, and a pointing device, such as a mouse, a trackball, cursor direction keys, or a motion sensor, for controlling a position of a small cursor image presented on the display 712 and issuing commands associated with graphical elements presented on the display 712, and one or more camera sensors 714 for capturing, recording and causing to store one or more still and/or moving images (e.g., videos, movies, etc.) which also may comprise audio recordings. Further, the display 712 may be a touch enabled display such as capacitive or resistive screen. In some embodiments, for example, in embodiments in which the computer system 700 performs all functions automatically without human input, one or more of the external input device 710, and the display 712 may be omitted.

In the illustrated embodiment, special purpose hardware, such as an ASIC 716, is coupled to the bus 702. The special purpose hardware is configured to perform operations not performed by the processor 704 quickly enough for special purposes. Examples of ASICs include graphics accelerator cards for generating images for the display 712, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 700 also includes one or more instances of a communication interface 718 coupled to the bus 702. The communication interface 718 provides a one-way or two-way communication coupling to a variety of external devices that operate with their own processors, such as printers, scanners and external disks. In general, the coupling is with a network link 720 that is connected to a local network 722 to which a variety of external devices with their own processors are connected. For example, the communication interface 718 may be a parallel port or a serial port or a Universal Serial Bus (USB) port on a personal computer. In some embodiments, the communication interface 718 is an Integrated Services Digital Network (ISDN) card, a Digital Subscriber Line (DSL) card, or a telephone modem that provides an information communication connection to a corresponding type of a telephone line. In some embodiments, the communication interface 718 is a cable modem that converts signals on the bus 702 into signals for a communication connection over a coaxial cable or into optical signals for a communication connection over a fiber optic cable. As another example, the communication interface 718 may be a Local Area Network (LAN) card to provide a data communication connection to a compatible LAN, such as Ethernet™ or an Asynchronous Transfer Mode (ATM) network. In one embodiment, wireless links may also be implemented. For wireless links, the communication interface 718 sends or receives or both sends and receives electrical, acoustic or electromagnetic signals, including infrared and optical signals that carry information streams, such as digital data. For example, in wireless handheld devices, such as mobile telephones like cell phones, the communication interface 718 includes a radio band electromagnetic transmitter and receiver called a radio transceiver. In certain embodiments, the communication interface 718 enables connection to the network 104. Further, the communication interface 718 can include peripheral interface devices, such as a thunderbolt interface, a Personal Computer Memory Card International Association (PCMCIA) interface, etc. Although a single communication interface 718 is depicted, multiple communication interfaces can also be employed.

The term “computer-readable medium” as used herein refers to any medium that participates in providing information to the processor 704, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as the storage device 708. Volatile media include, for example, the dynamic memory 706. Transmission media include, for example, twisted pair cables, coaxial cables, copper wire, fiber optic cables, and carrier waves that travel through space without wires or cables, such as acoustic waves, optical or electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a USB flash drive, a Blu-ray disk, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 716.

The network link 720 typically provides information communication using transmission media through one or more networks to other devices that use or process the information. For example, the network link 720 may provide a connection through the local network 722 to a host computer 724 or to ISP equipment operated by an Internet Service Provider (ISP).

A server 726, connected to the Internet, hosts a process that provides a service in response to information received over the Internet. For example, the server 726 hosts a process that provides information representing video data for presentation at the display 712. It is contemplated that the components of the computer system 700 can be deployed in various configurations within other computer systems, e.g., the host 724 and the server 726.

At least some embodiments of the invention are related to the use of the computer system 700 for implementing some or all of the techniques described herein. According to one embodiment of the invention, those techniques are performed by the computer system 700 in response to the processor 704 executing one or more sequences of one or more processor instructions contained in the memory 706. Such instructions, also called computer instructions, software and program code, may be read into the memory 706 from another computer-readable medium such as the storage device 708 or the network link 720. Execution of the sequences of instructions contained in the memory 706 causes the processor 704 to perform one or more of the method steps described herein. In alternative embodiments, hardware, such as the ASIC 716, may be used in place of or in combination with software to implement the invention. Thus, embodiments of the invention are not limited to any specific combination of hardware and software, unless otherwise explicitly stated herein.

Various forms of computer readable media may be involved in carrying one or more sequence of instructions or data or both to the processor 704 for execution. For example, instructions and data may initially be carried on a magnetic disk of a remote computer such as the host 724. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 720. An infrared detector serving as the communication interface 718 receives the instructions and data carried in the infrared signal and places information representing the instructions and data onto the bus 702. The bus 702 carries the information to the memory 706 from which the processor 704 retrieves and executes the instructions using some of the data sent with the instructions. The instructions and data received in the memory 706 may optionally be stored on the storage device 708, either before or after execution by the processor 704.

### V. ALTERNATIVE EMBODIMENTS

While certain embodiments of the invention are described above, and FIGS. 1 to 7 disclose the best mode for practicing the various inventive aspects, it should be understood that the invention can be embodied and configured in many different ways without departing from the spirit and scope of the invention.

Embodiments are disclosed above in the context of exchanging healthcare data of a client of an assisted living service provider between the assisted living service provider and one or more subscribers designated by the client to receive periodic and aperiodic updates regarding the welfare of the client.

Embodiments, as disclosed above, are directed to a system that facilitates the transmission of healthcare data of the client of an assisted living/skilled nursing service provider to one or more subscriber devices, each device corresponding to a subscriber designated by the client. The data transmitted is free from medical jargon and is presented in a legible format.

Embodiments, as disclosed above, are directed to a system which extracts healthcare data from a medical record database and transmits transformed data to designated subscribers without the intervention of any human administrator. Extraction and transmission of healthcare data is in compliance with statutory protocols as the HIPAA.

Embodiments, as disclosed above, are directed to systems and methods that send queries from one or more subscribers directed to an intended recipient, the details of whom may be provided along with the query or may be identified by the system based on the parsing of the query to locate preset keywords. The query is routed to the intended recipient. Answers from the intended recipient are subsequently sent to the subscribers through the system.

In some embodiments, the data is presented in a newsfeed format. The messages can also be displayed as periodic updates (e.g., daily, hourly etc.). The messages can also be displayed as per preferences of the subscriber. For example, the messages can be displayed at a specific time of the day chosen by the subscriber. The messages can also be displayed aperiodically in accordance with an event trigger (for example, an emergency notification) detected by the system. Further, the newsfeed presentation enables a subscriber to view updates in a sequential manner. The subscriber can scroll up or down to find a particular update. Further, new messages or updates can trigger an alarm on the subscriber device. The alarm can include, but not limited to, an audible alarm, a vibration of the subscriber device, flashing of the display unit of the subscriber device, and the like.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary embodiments disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

While the subject matter has been described in detail with reference to exemplary embodiments thereof, it will be apparent to one skilled in the art that various changes can be made, and equivalents employed, without departing from the scope of the invention. All related art references discussed in the Background section above are hereby incorporated by reference in their entirety.

What is claimed is:

1. A method of exchanging messages between an assisted living/skilled nursing service provider and one or more subscribers, the method comprising:
retrieving, by a server, data corresponding to a client of the assisted living service provider from one or more medical record databases;
transforming, by the server, the data retrieved from one or more medical record databases in accordance with a predefined format;
storing the transformed data in a local database communicably coupled to the server; and
sending one or more messages to one or more subscriber devices, the one or more messages comprising at least one of a health status, an activity status, an assistance status, a nutrition status and a medication status of the client.

2. The method of claim 1, further comprising:
receiving, at the server, one or more subscriber profiles corresponding to the one or more subscribers;
sending, by the server, notifications to the one or more subscriber devices;
receiving, at the server, responses to the notifications sent to the one or more subscriber devices; and
creating, by the server, a group based on the responses received from the one or more subscriber devices, each member of the group being authorized to receive information related to the client of the assisted living service provider.

3. The method of claim 2, wherein the one or more subscriber profiles comprises communication information of the one or more subscribers.

4. The method of claim 2, further comprising authenticating the one or more subscriber profiles based on the responses received from the one or more subscriber devices.

5. The method of claim 1, wherein the one or more messages is encrypted using a security token.

6. The method of claim 5, further comprising decrypting, by an application installed on the one or more subscriber devices, the one or more messages.

7. The method of claim 1, further comprising:
receiving a query from the one or more subscriber devices;
routing the query to an intended recipient of the assisted living service provider;
receiving an answer from the intended recipient; and
sending the answer to the one or more subscriber devices.

8. The method of claim 1, further comprising sending an emergency notification to the one or more subscribers.

9. The method of claim 1, further comprising:
updating the transformed data in the local database; and
sending the one or more messages to the one or more subscriber devices based on the updated data.

10. The method of claim 1, further comprising displaying the one or more messages on a user interface of the one or more subscriber devices in the form of a newsfeed.

11. A method of exchanging messages between an assisted living service provider and one or more subscribers, the method comprising:
retrieving, by a server, data corresponding to a client of the assisted living service provider from one or more medical record databases;
transforming, by the server, the data retrieved from one or more medical record databases in accordance with a predefined format;
storing the transformed data in a local database communicably coupled to the server;
sending notifications to one or more subscriber devices;
receiving responses to the notifications sent to the one or more subscriber devices;
authenticating one or more subscribers based on the responses received from the one or more subscriber devices; and
sending one or more messages to the one or more subscriber devices corresponding to the one or more authenticated subscribers, the one or more messages comprising at least one of a health status, an activity status, an assistance status, a nutrition status and a medication status of the client.

12. The method of claim 11, wherein the one or more messages is encrypted using a security token.

13. The method of claim 12, further comprising decrypting, by an application installed on the one or more subscriber devices, the one or more messages.

14. The method of claim 11, further comprising:
receiving a query from the one or more subscriber devices;
routing the query to an intended recipient of the assisted living service provider;
receiving an answer from the intended recipient; and
sending the answer to the one or more subscriber devices.

15. The method of claim 11, further comprising sending an emergency notification to the one or more subscribers.

16. The method of claim 11, further comprising:
updating the transformed data in the local database; and
sending the one or more messages to the one or more subscriber devices based on the updated data.

17. The method of claim 11, further comprising displaying the one or more messages on a user interface of the one or more subscriber devices in the form of a newsfeed.

18. A system for exchanging messages between an assisted living service provider and one or more subscribers, the system comprising:
a server communicably coupled to one or more medical record databases and one or more subscriber devices, the server configured to:
receive a subscriber profile from each of the plurality of subscribers;
retrieve data corresponding to a client of the assisted living service provider from the one or more medical record databases;
transform the data retrieved from one or more medical record databases in accordance with a predefined format;
store the transformed data in a local database communicably coupled to the server; and
send one or more messages to the one or more subscriber devices, the one or more messages comprising at least one of a health status, an activity status, an assistance status, a nutrition status and a medication status of the client; and
an application installed on the one or more subscriber devices, the application configured to display the one or more messages on a user interface.

19. The system of claim 18, wherein the application is further configured to receive
a query from the one or more subscribers and transmit the query to the server, and wherein the server is further configured to:
route the query to an intended recipient of the assisted living service provider;
receive an answer from the intended recipient; and
send the answer to the one or more subscriber devices,
wherein the application is further configured to display the answer on the user interface.

20. The system of claim 18, wherein the application is further configured to display the or more messages on the user interface in the form of a newsfeed.
